(19) United States
(12) Patent Application Publication
(10) Pub. No.: US 2006/0271451 A1
(43) Pub. Date: Nov. 30, 2006

(54) System and method for providing data to tax preparation software

(76) Inventor: George Varughese, New Hyde Park, NY (US)

Correspondence Address: CARR & FERRELL LLP, 2200 GENG ROAD, PALO ALTO, CA, 94303, US

(21) Appl. No.: 11/510,531

(22) Filed: Aug. 24, 2006

Related U.S. Application Data
(60) Provisional application No. 60/787,934, filed on Mar. 30, 2006.

(51) Int. Cl. G06F 17/22; G07F 19/00

(52) U.S. Cl. 705/31

(57) ABSTRACT

Systems and methods for providing data to tax preparation software are provided. In exemplary embodiments, raw tax data is collected from a user via at least one data form. When the data form is completed, the raw tax data is converted into standardized tax data. The standardized tax data may then be imported into the tax preparation software for processing. In exemplary embodiments, the tax preparation software comprises commercially available tax preparation software.

### CROSS REFERENCE TO RELATED APPLICATION

The present application claims the priority benefit of U.S. Provisional Patent Application No. 60/787,934 filed Mar. 30, 2006 and entitled “Method and System for the Filing of Tax Returns” which is herein incorporated by reference.

### BACKGROUND OF THE INVENTION

1. Field of the Invention

Embodiments of the present invention relate generally to data processing, and more particularly to processing tax data.

2. Description of Related Art

With the advent of the Internet, more business is being transacted via the use of the Internet. Additionally, individuals recognize the ease and convenience of performing transactions via the Internet. Along these lines, the filing of tax returns electronically has increased in number. As a result, Internet-based tax preparation services have developed.

Disadvantageously, prior art methods of electronic filing from an Internet-based collection point of a tax preparation service have required creation of complex, customized tax software in order to view, process, and edit tax returns before submitting the tax returns to the government (e.g., state tax agencies and the IRS). The creation of such customized tax software is not only time consuming, but also requires a significant investment of financial resources and programming skill in order to maintain and upgrade the customized tax software.

The cost for maintaining the customized tax software is exacerbated by the constantly changing tax code. Every time a change is made to the tax code, the customized tax software must be upgraded to incorporate the change. This may require having a programmer develop a software patch or upgrade to the customized tax software. Additionally, the tax preparation service may have to temporarily shut down when the upgrade is being implemented.

Therefore, there is a need for efficient systems and methods for preparing tax documents.

### SUMMARY OF THE INVENTION

Embodiments of the present invention provide systems and methods for providing data for preparation of tax documents, such as tax returns, utilizing commercially available tax software. In exemplary embodiments, raw tax data is collected from a user via at least one data form. In one embodiment, the data collection occurs at an information collection point located on the Internet. In this embodiment, the data forms are online forms into which the user may enter their raw tax data. The raw tax data may be stored in a data file associated with the user.

When the data form is completed, the raw tax data in the data file is converted into standardized tax data. In some embodiments the standardize tax data is in a flat-file, text-base format, such as XML format.

In exemplary embodiments, the standardized tax data in the standardize data file is transferred from the information collection point to a tax service provider. In some embodiments, the transfer may be automatically triggered upon detection of a newly standardized data file. In other embodiments, the automatic transfer may be triggered by other means. The transfer may be initiated by a delivery module located at the information collection point. Alternatively, the transfer may be initiated by a transfer module located at the tax service provider.

The transferred standardized tax data may then be imported into conventional, commercially available tax preparation software. In exemplary embodiments, the importation is automatically triggered by an import module upon detection of the standardized tax data. The standardized tax data may also be saved to a database. In some embodiments, a plurality of databases is provided, and the data is saved to the appropriate database based on the success or failure of the importation of the standardized tax data into the tax preparation software.

### BRIEF DESCRIPTION OF THE DRAWINGS

FIG. 1 is block diagram of an exemplary environment in which embodiments of the present invention may be practiced;

FIG. 2 is a block diagram of an exemplary information collection point;

FIG. 3 is a block diagram of an exemplary tax service provider system;

FIG. 4 is a flowchart of an exemplary method for preparing a tax document, according to one embodiment of the present invention;

FIG. 5 is a flowchart of an exemplary method for transferring return files to the tax service provider system; and

FIG. 6 is a flowchart of an exemplary method for importing the data in the return file into tax software.

### DETAILED DESCRIPTION OF EXEMPLARY EMBODIMENTS

Embodiments of the present invention provide systems and methods for preparing tax documents (e.g., tax returns). The system is configured to operate in an environment that allows the use of conventional (e.g., commercially available, off-the-shelf) tax preparation software. The use of this type of tax preparation software allows a most current version of the tax preparation software to be utilized without high expenditures or down-time associated with upgrading proprietary or customized tax preparation software of a tax service provider.

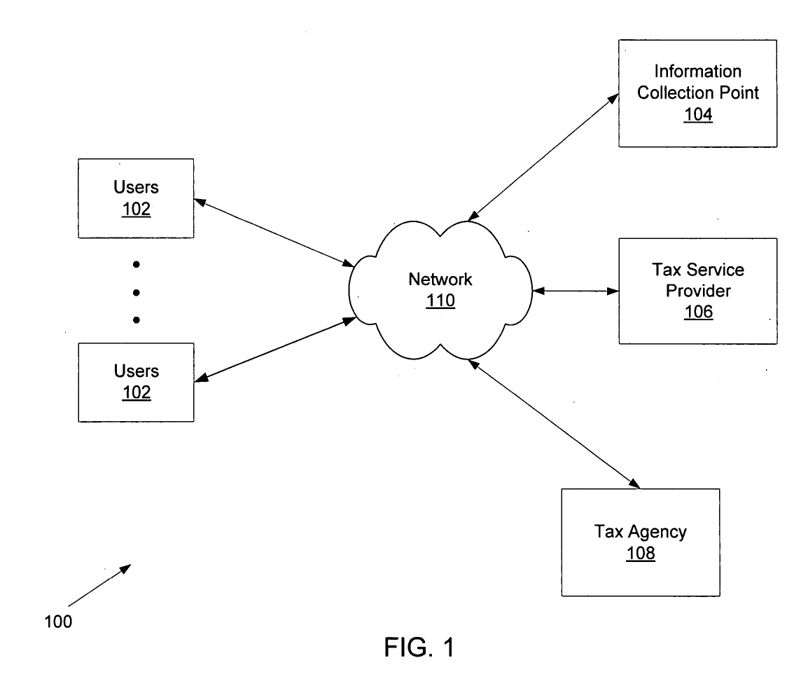

FIG. 1 is an exemplary environment 100 in which embodiments of the present invention may be practiced. The exemplary environment 100 comprises at least one user 102, an information collection point 104, and a tax service provider 106 coupled in communication to a tax agency 108 via a network 110. In one embodiment, the network 110 is the Internet. In a further embodiment, the network 110 may comprise one or a combination of the Internet, postal service, local area network, wide area network, and/or phone/fax services.

In exemplary embodiments, the information collection point 104 collects raw tax data from the user 102. The raw tax data is then converted into standardized tax data. In some embodiments, standardized tax data is transferred to the tax service provider 106, which then imports the standardized tax data into conventional tax preparation software. The conventional tax preparation software processes the standardized tax data to generate tax documents, such as tax returns.

The tax agency 108 may comprise any government agency responsible for administering tax collection. In one embodiment, the tax agency 108 is the Internal Revenue Server (IRS). In alternative embodiments, the tax agency 108 is a state or local tax agency (e.g., California Franchise Tax Board).

In exemplary embodiments, the user 102 is an entity which is required to file a tax return or other tax documents with the tax agency 108. For example, the user 102 may be an individual tax payer. Alternatively, the user 102 may be a business entity, such as a company or corporation.

In exemplary embodiments, the information collection point 104 is a website server configured to provide a website to collect raw tax data from a user that is required in order to complete one or more tax documents for submission to the tax agency 108. The website may, in some embodiments, embody one or more data forms which provide fields for the user 102 to enter the required raw tax data. The required raw tax data may comprise a social security number, last name, address, birthday, adjusted gross income (AGI) amount, AGI year, and other tax related information.

Once the data form(s) are completed, the raw tax data is forwarded to the tax service provider 106 for processing. In alternative embodiments, the information collection point 104 is embodied within the tax service provider 106. For example, the information collection point 104 may comprise a computing device which provides one or more web pages on which the user 102 enters their raw tax data. Alternatively, the information collection point 104 may be embodied on a computing device coupled to the tax service provider 106 (e.g., via a local area network). In these embodiments, the raw tax data may be automatically received by the tax service provider 106 and utilized to prepare the tax documents (e.g., tax returns).

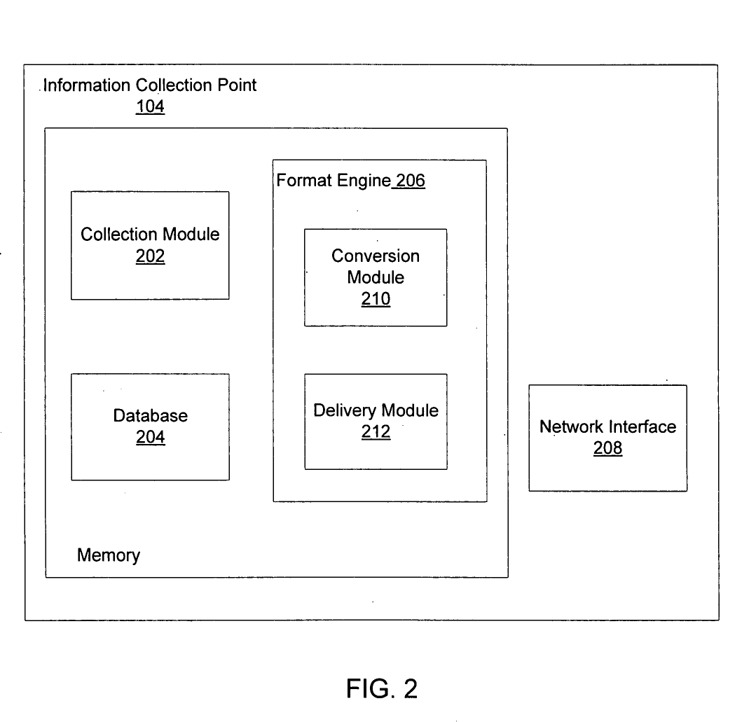

In alternative embodiments, the information collection point 104 may comprise a plurality of components configured to obtain the client information (e.g., raw tax data). For example, the information collection point 104 may comprise in-person, phone, mail, and/or fax collection of raw tax data. The raw tax data may then be manually entered to populate a data file for the user 102, for example, by the tax service provider 106. The information collection point 104 will be discussed in more detail in connection with FIG. 2.

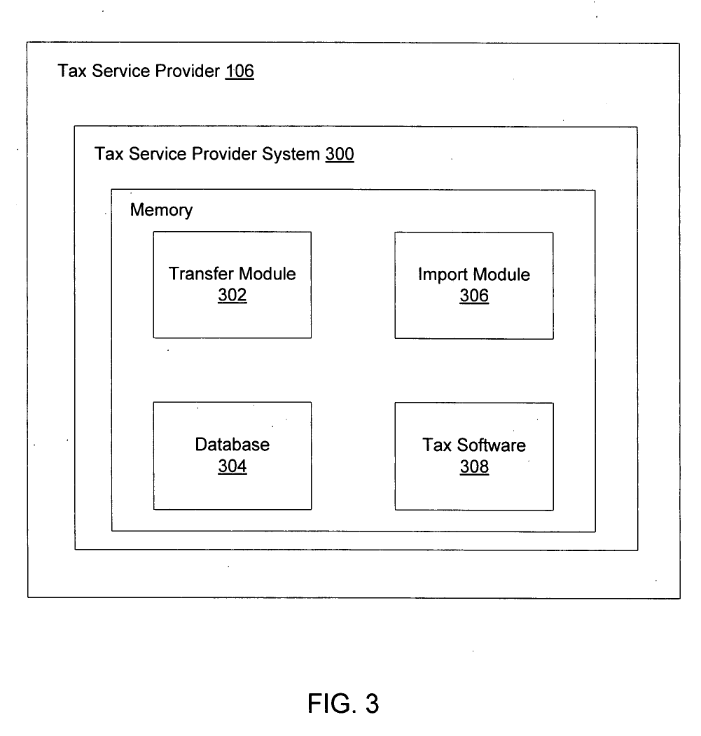

The tax service provider 106 is an entity which prepares the tax documents (e.g., tax returns) for the user 102. For example, the tax service provider 106 may be a tax preparation company, an accountant, or any other entity having legal authority to prepare tax documents on behalf of the user 102. The tax service provider 106 will be discussed in more details in connection with FIG. 3 below.

In exemplary embodiments, the raw tax data is not in a form that can be processed by conventional (e.g., commercial, off-the-shelf) tax preparation software. Therefore, embodiments of the present invention convert the raw tax data into a format that allows the formatted tax data to be imported into the conventional tax preparation software.

It should be noted that FIG. 1 is exemplary and does not limit the scope of the present invention. For example, alternative embodiments may comprise any number of users 102, information collection points 104, tax service providers 106, and tax agencies 108.

Referring now to FIG. 2, the exemplary information collection point 104 is shown in more detail. In exemplary embodiments, the information collection point 104 comprises a collection module 202, at least one database 204, a format engine 206, and a network interface 208. Alternative embodiments may comprise more, less, or functionally equivalent components.

The exemplary collection module 202 is configured to interface with the user 102 via the network interface 208 in order to collect the user's raw tax data. In one embodiment, the collection module 202 generates and provides one or more data forms having fields into which the user 102 may enter requested raw tax data. The data form may be presented to the user 102 on a website that the user 102 visits via the network 110. Alternatively, the data form may be a hard copy printout which the user 102 can physically fill out. In yet further embodiments, the data form may be presented to a tax service provider 106 personnel who will ask the user 102 for the raw tax data requested on the data form. Other embodiments for presenting data forms to the user 102 will be apparent to one skilled in the art.

In some embodiments, the collection module 202 may also request the user 102 correct any incorrect information in the user data forms. As such, the exemplary collection module 202 may be configured to determine whether information supplied via the data forms are incorrect. For example, if the user provides a social security number with an inadequate number of digits, the collection module 202 will require the user 102 to reenter their social security number.

In exemplary embodiments, the user 102 will initiate a session with the collection module 202 to complete the one or more data forms. The user 102 may set up a user name and password that is used to associate the user 102 with their data file. Thus, if a user 102 does not fully complete the data form in one session, the user 102 may save the data already provided into their data file. Later, the user 102 can return to complete the data form, for example, by logging into another session with the collection module 202, and accessing the incomplete data form associated with their data file.

As part of the data provided by the user 102, the user will provide contact information (e.g., e-mail address, phone number, mailing address, etc.). If the tax service provider 106 needs to communicate with the user 102, the tax service provider 106 will have the information to do so. For example, if there is an error in raw tax data that was submitted, the tax service provider 106 may send an e-mail to the user 102 instructing them to log back in and provide the correct data.

Information on the user data forms is stored in the associated data file in the database 204. In exemplary embodiments, each data file will contain all the raw tax data for a particular user 102. While the database 204 is shown being embodied within the information collection point 104, alternatively, the database 204 may be located outside of the information collection point 104 but be couple thereto.

The format engine 206 is configured to format or convert the raw tax data in the data file into standardized tax data and provide the standardized tax data to the tax service provider 106. In exemplary embodiments, the standardize tax data may be directly imported into the conventional tax preparation software, as will be discussed in more detail below. The exemplary format engine 206 comprises a conversion module 210 and a delivery module 212.

In exemplary embodiments, when the collection module 202 detects that a data form is completed, the conversion module 210 converts the raw tax data from the data form into the standardized tax data. In exemplary embodiments, the conversion is automatically triggered by the completion of the data form. In alternative embodiments, the conversion may be automatically triggered by other means, such as by an input of an operator (e.g., personnel associated with the tax service provider 106) initializing the conversion module 210. In one embodiment, the conversion may be performed through asp.net by taking the raw tax data from a SQL database and outputting necessary fields into a text file. In some embodiments, the standardized tax data may be in a XML, CSV, JFile, or tab-delineated format. For example, JFile may be utilized specifically with UTS Commercial Tax Software, whereas .xml may be used with ATX Family of Commercial Tax Software. In alternative embodiments, the standardized tax data may comprise other flat-file, text-based formats. The standardized tax data may be stored in the database 204, for example, in a standardized data file associated with the user 102.

Alternatively, the conversion may be performed by extracting the raw tax data and storing the extracted tax data into a defined output database or table as a record. Each record represents a user's individual tax data. The records are then organized for transfer to the tax service provider 106. In yet a further embodiment, the conversion may occur at the tax service provide 106. In this embodiment, the conversion module 210 is embodied within the tax service provider 106.

Once the raw tax data is converted, the standardized tax data is transferred to the tax service provider 106 via the delivery module 212, according to one embodiment. The standardized tax data in a (standardized) data file may be forwarded via FTP to a local device of the tax service provider 106. The local device may comprise a server, database, or other computing device. The delivery module 212 may be automatically activated. For example, the delivery module 212 may monitor the database 204 for recently standardized (e.g., converted) data files, and automatically trigger the transfer of the data when a new standardized data file is detected. In other embodiments, the delivery module 212 is automatically triggered by other means, such as by an input from an operator.

In an alternative embodiment, the delivery module 212 does not initiate the data transfer. Instead, a transfer module located at the tax service provider 106 pulls the standardized data file from the information collection point 104. In one embodiment, the transfer module periodically checks the database 204 to determine if any new standardized data files or data files associated with completed data form(s) are available. If data files are available, the transfer module will automatically trigger the transfer of the data into, for example, a local device of the tax service provider 106. In other embodiments, the automatic trigger may comprise other means, such as by an input from an operator. For example, the transfer module may pull the data to the tax service provider, or the transfer module may instruct the delivery module 212 to transfer the data. The transfer module will be discussed in more detail in conjunction with FIG. 3.

In alternative embodiments, the delivery mechanism may comprise e-mail, delivery of physical media, or opening the standardized data file on the Internet server (e.g., at the information collection point 104) copying and saving the data locally. In embodiments where the information collection point 104 is located on a LAN, the transfer may be via a LAN connection. Other forms of file transfer are contemplated and within the scope of embodiments of the present invention.

Further, some embodiments may not require transfer of the data in the standardized data file. For example, if the information collection point 104 is embodied within a tax service provider 106 device which also processes the conventional tax preparation software, the standardized tax data is already located at the local server.

FIG. 3 is a detail blocked diagram of the tax service provider 106. In exemplary embodiments, the tax service provider 106 comprises at least one tax service provider system 300. In exemplary embodiments, the tax service provider system 300 is a computing device comprising a transfer module 302, database 304, an import module 306, and tax preparation software 308. In exemplary embodiments, the tax preparation software 308 is a conventional (e.g., commercially available, off-the-shelf) tax preparation software. That is, the tax preparation software 308 does not need to be customized to the tax service provider system 300. In alternative embodiments, the conventional tax preparation software 308 may be slightly or fully customized.

It should be noted that the database 304 may comprise any number of databases 304 or storage device. Additionally, the database 304 may comprise one or more libraries into which different standardized data files may be stored as will be discussed further infra. In alternative embodiments, the database 304 may be located outside of the tax service provider system 300 but be coupled thereto.

The transfer module 302 is configured to receive the data in the standardized data file from the information collection point 104. In some embodiments, the data is locally stored into the database 304, while other embodiments will store the data after an attempt to import the data into the tax preparation software 308. As previously described, some embodiments of the transfer module 302 will monitor the information collection point 104 to detect if new standardized data files are available for transfer. The transfer module 302, in these embodiments, will then automatically trigger the transfer of the standardized data file.

While embodiments of the present invention discuss the transfer of the standardized data file, alternative embodiments may provide a copy of the standardized data file to the tax service provider 106. That is, an original standardized data file may remain at the information collection point 104, and a copy of the standardized data file is provided to the tax service provider 106. This embodiment may be useful in providing a backup copy of the standardized data file. In yet other embodiments, the data file containing raw tax data is transferred and the conversion to a standardized data file occurs at the tax service provider system 300.

The import module 306 imports the data in the standardized data file into the tax preparation software 308. In exemplary embodiments, the import module 306 is automatically triggered to import data from any newly detected standardized data files. For example, the import module 306 can automatically take the standardized tax data from the standardized data file upon receipt by the tax service provider 106, and import the standardized tax data into the tax preparation software 308. Alternatively, the import module 306 monitors the database 304 for new standardized data files, and upon detection, automatically import the standardized data into the tax preparation software 308. Other automatic triggers for importation of the standardized tax data into the tax preparation software 308 are known to those skilled in the art. For example, importation may be automatically triggered based on an operator input.

The standardized tax data may be imported into an internal or external data store of the tax preparation software 308. For example, the import module 306 may initiate a function within a .dll file (which may exist for the tax preparation software 308 or is created therefore) to import the standardized tax data into the data store. Alternatively, the .dll file may be incorporated into the import module 306.

In some embodiments, the import module 306 will determine if standardized tax data from a standardized data file already has been imported into the tax software 308. If the standardize tax data has already been imported, the standardized data file may be saved into a database 304 (e.g., a duplicate file database) or a duplicate file library. If the standardized tax data has not been previously imported, it will be imported into the tax software 308 and the standardized data file may be saved into the database 304 (e.g., an archive database) or an archive library.

If an error occurs during the importing process, the import module 306 may save the standardized data file into the database 304 (e.g., a reprocess database) or a reprocess library for reprocessing at a later time.

In some embodiments, the import module 306 can use different methods to import standardized tax data into different conventional tax preparation software 308. For example, one importation method may be utilized to import the standardized tax data into TurboTax, and a different importation method may be utilized to import the standardized tax data into TaxAct. Other exemplary tax preparation software 308 may comprise the CCH family of Commercial Tax Software, UTS Family of Commercial Tax Software, ATX Family of Commercial Tax Software, Tax Vision family of Commercial Ta Software, and others.

The tax preparation software 308 comprises any commercially available (e.g., off the shelf) tax preparation software. Because the tax code is constantly changing, the tax preparation software 308 must be updated to reflect the new tax codes. Since the tax preparation software 308 is commercially available, the tax service provider 106 does not need to commit to large customization, upgrade, and maintenance costs associated with proprietary tax software which are customized to the tax service provider 106. The tax service provider 106 merely needs to obtain and install a latest version of the commercially available tax preparation software 308. Although FIG. 1-FIG. 3 describe exemplary systems for collecting and processing tax data, it will be understood that embodiments of the present invention are not limited to such configurations but is intended to encompass any configuration configured to carry out functions described herein.

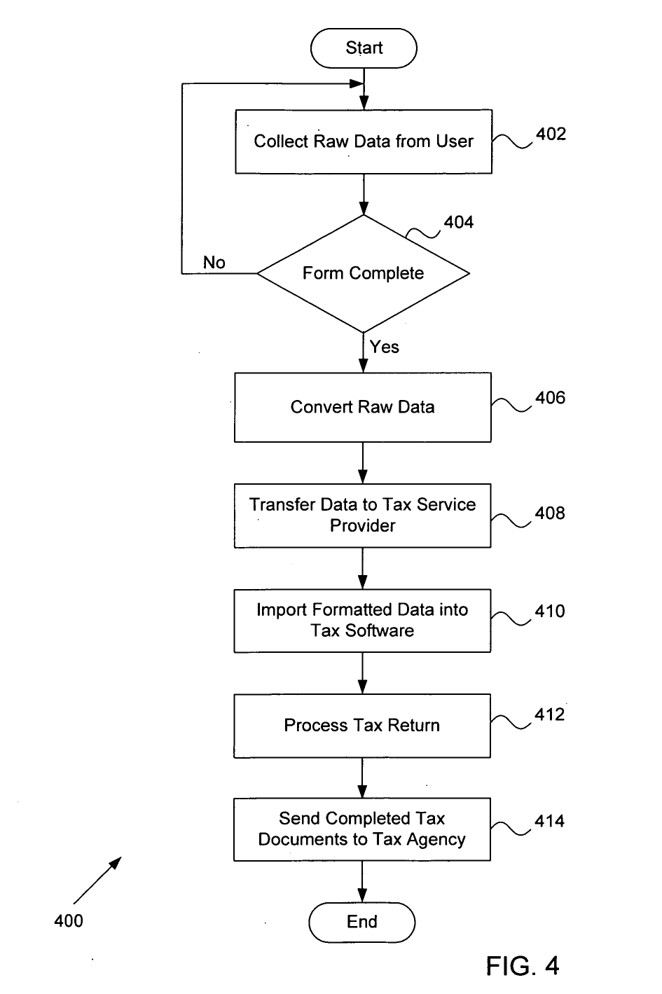

Referring now to FIG. 4, an exemplary flowchart 400 of a method for preparing a tax document is shown. In step 402, raw tax data is collected from the user 102. In exemplary embodiments, the user 102 accesses a website of an information collection point 104. The information collection point 104 presents one or more data forms into which the user 102 provides the raw tax data. The raw tax data is stored into a data file that is associated with the user 102.

In step 404, the information collection point 104 determines if the data form is complete. If the data form is not complete, raw tax data continues to be collected from the user 102. The data collection can occur in one or more sessions between the user and the information collection point 104.

If the data form is completed, however, the data file containing the raw tax data from the data forms is formatted or converted in step 406. The conversion may be automatically triggered, for example, upon completion and/or save of a completed data form. In an alternative embodiment, the conversion may be automatically triggered upon, for example, a command or input from an operator.

In exemplary embodiments, the format or conversion is performed by the conversion module 210. In one embodiment, the conversion module 210 takes the raw tax data from a SQL database and outputs necessary fields into a text file. For example, the data file may be converted into a .xml, .csv, JFile, or tab-delineated standardized data file. In alternative embodiments, the standardized data file may comprise other flat-file, text-based formats. The standardized data file may be stored in the database 204. Alternatively, the conversion may be performed by extracting the raw tax data and storing the extracted data into a defined output database or table as a record.

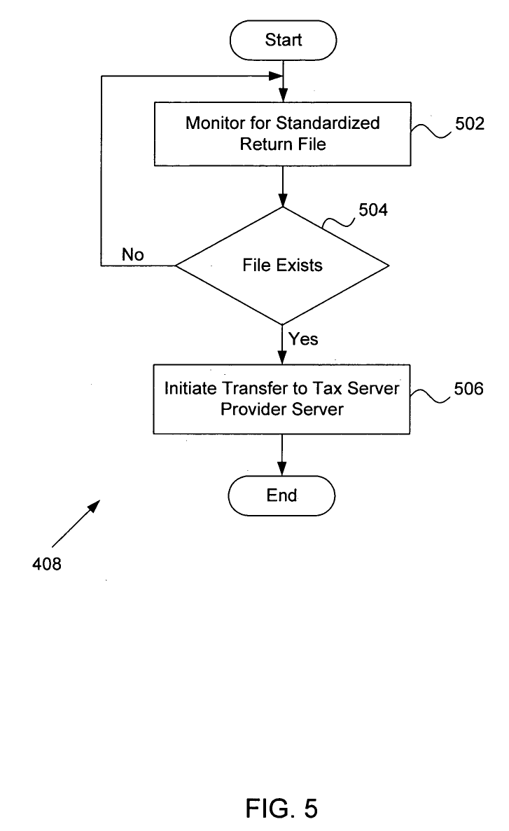

In step 408, the standardized tax data in the standardized data file is transferred to the tax service provider 106. Step 408 will be discussed in more detail in connection with FIG. 5.

Once the standardized data file is received at the tax service provider 106, the standardized tax data is imported into the conventional tax preparation software 308 in step 410. In exemplary embodiments, the import module 306 is automatically triggered to import the standardized tax data in the standardized data file into the tax preparation software 308. In one embodiment, the import module 306 may monitor for any newly transferred standardized data files. If a new standardized data file is detected, the standardized tax data from the detected standardized data file is automatically imported into the tax preparation software 308. In alternative embodiments, the import module 306 is automatically triggered by other means, such as for example, by an input from an operator, by the transfer module 302 upon receipt of the standardized data file, etc.

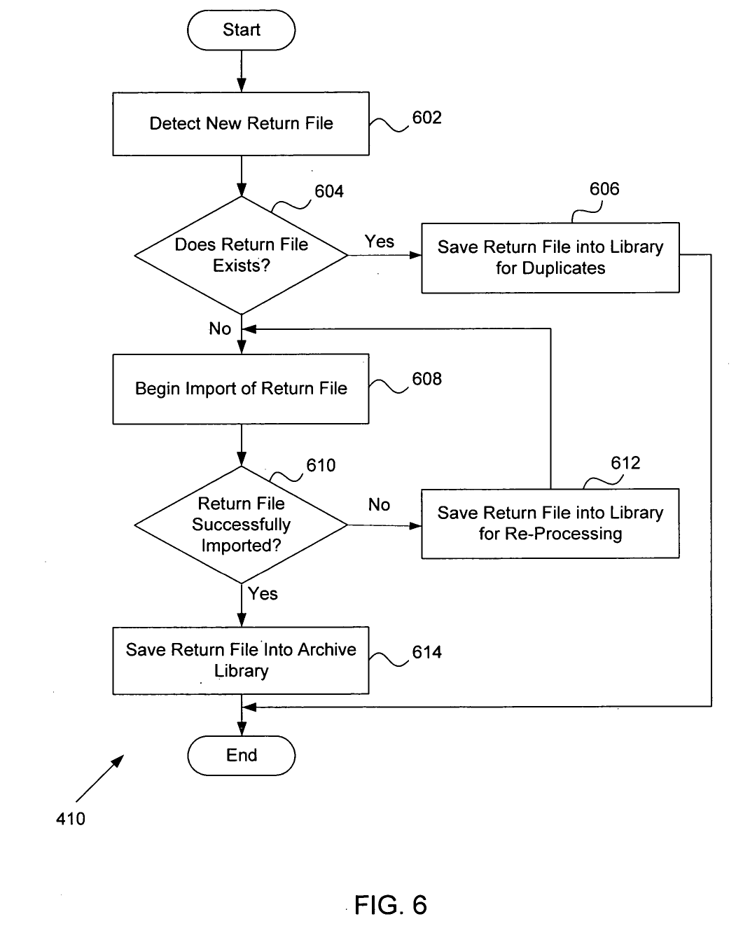

The standardized tax data may be imported into an internal or external data store of the tax preparation software 308. For example, the import module 306 may initiate a function within a .dll file (which may exist for the tax preparation software 308 or is created therefore) to import the standardized tax data into the data store. Alternatively, the .dll file may be incorporated into the import module 306. Step 410 will be discussed in further detail in connection with FIG. 6.

The tax preparation software 308 then processes the standardized tax data in step 412. In exemplary embodiments, the tax preparation software 308 receives the imported standardized tax data, calculates tax liability, and generates required tax documents. In exemplary embodiments, the tax documents comprise federal tax forms. The tax documents may further comprise state tax forms and supplemental federal tax forms not specifically addressed by the collection point (e.g., earned income worksheet, schedule d, schedule e, etc). By generating the state and supplemental federal tax forms utilizing the same raw data obtained by the collection point for the federal tax forms, a significant time savings is obtained. In alternative embodiments, raw data for completing state forms may be collected at the collection point 104.

The completed tax documents are then submitted to the tax agency 108 in step 414. In embodiments where the tax documents are to be submitted electronically to the tax agency 108, the tax documents are converted into an acceptable format electronic file for the particular tax agency 108. The electronic file is then sent to the tax agency 108. If errors are detected, the errors are corrected and revised tax documents are regenerated, converted, and resubmitted to the tax agency 108.

In embodiments where the tax documents are not submitted electronically, physical copies of the tax documents may be made. These physical copies may then be mailed, for example, to the tax agency 108.

The flowchart 400 of FIG. 4 is exemplary. Alternative embodiments may comprise more or less steps, and the steps may be performed in a different order. For example, transfer step 408 may not be necessary in an embodiment where the information collection point 104 is embodied within a computing device also comprising the import module 306 and/or the tax preparation software 308.

Referring now to FIG. 5, an exemplary method for transferring the standardized tax data in the standardized data file to the tax service provider 106 (step 408) is shown. In step 502, the information collection point 104 is monitored for the presence of at least one new standardized data file. In some embodiments, the delivery module 212 monitors for newly formatted standardized data files. Alternatively, a transfer module 302 at the tax service provider 106 may monitor for new standardized data files.

In step 504, a determination is made as to whether any new standardized data files are detected. If a new standardized data file is detected, transfer of the standardized tax data in the standardized return file is initiated in step 506. In the embodiment where the delivery module 212 monitors the information collection point 104, the delivery module 212 forwards the standardized tax data to the tax service provider system 300. In the embodiment where the transfer module 302 monitors the information collection point 104, the transfer module 302 initiates the file transfer by either instructing the delivery module 212 to forward the standardized tax data in the standardized data file or pulling the standardized tax data from the database 204 of the information collection point 104.

Referring now to FIG. 6, a flowchart of an exemplary method for importing the standardized tax data from the standardized data file into the tax preparation software 308 (step 410) is shown. In step 602, a new standardized data file is detected at the tax service provider system 300. In one embodiment, the import module 306 monitors the database 304 for any newly transferred standardized data files. In an alternative embodiment, the import module 306 will detect the new standardized data file as soon as it is received from the information collection point 104 (e.g., prior to any save to the database 304). In yet a further embodiment, the transfer module 302 will notify the import module 306 of the presence of the new standardized data file. In exemplary embodiments, the detection of the new standardized data file will automatically trigger the importation of the tax data into the tax preparation software 308. In alternative embodiments, other means for automatically triggering the importation of the standardized tax data is utilized, such as for example, an input from an operator.

In step 604, a determination is made as to whether the standardized data file already exists at the tax service provider system 300. For example, if a user 102 accidentally enters his information twice into the data form, the transfer module 302 or the import module 306 will determine that the standardized data file already exists. Because the standardized data file has already been imported into the tax software 308, the standardized data file may be saved into the (duplicate file) database 304 or duplicate file library in step 606.

If a new standardized data file is detected in step 604, the standardized tax data in the standardized data file is imported into the tax preparation software 308 in step 608. The standardized tax data may be imported into an internal or external data store of the tax preparation software 308. For example, the import module 306 may initiate a function within a .dll file (which may exist for the tax software 308 or is created therefore) to import the standardized tax data into the data store. Alternatively, the .dll file may be incorporated into the import module 306.

In step 610, the import module 306 determines if the standardized tax data in the standardized data file is successfully imported into the tax preparation software 308. If the standardized tax data has not been properly imported, the standardized data file may be saved into the (reprocess) database 304 or reprocess library for reprocessing in step 612.

If, however, the data is successfully imported into the tax preparation software 308, the standardized data file may be saved into the (archive) database 304 or archive library in step 614.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A system for providing data to tax preparation software, comprising:
a collection module configured to collect raw tax data from a user;
a conversion module configured to convert the collected raw tax data into standardized tax data; and
an import module configured to be automatically triggered to import standardized tax data into the tax preparation software for processing.

2. The system of claim 1 wherein the collection module is further configured to generate and present data forms into which the user provides the raw tax data.

3. The system of claim 1 further comprising a delivery module configured to be automatically triggered to transfer the standardized tax data to a tax service provider system.

4. The system of claim 1 further comprising a transfer module configured to monitor for the standardized tax data.

5. A method for providing data to tax preparation software, comprising:
receiving raw tax data from a user;
converting the raw tax data into standardized tax data; and
automatically triggering importation of the standardized tax data into the tax preparation software for processing.

6. The method of claim 5 wherein receiving raw tax data comprise providing at least one data form into which the user provides the raw tax data.

7. The method of claim 5 wherein receiving raw tax data comprises storing the raw tax data into a data file associated with the user.

8. The method of claim 5 wherein receiving raw tax data comprises collecting the raw tax data online.

9. The method of claim 5 wherein receiving raw tax data comprises storing the raw tax data on a web-based server.

10. The method of claim 5 wherein converting the raw tax data occurs automatically upon completion of a data form.

11. The method of claim 5 wherein converting the raw tax data comprises converting the raw tax data into .xml format.

12. The method of claim 5 wherein converting the raw tax data comprises converting the raw tax data into a flat-file, text-based format.

13. The method of claim 5 further comprising triggering automatic transfer of the standardize tax data to a tax service provider system.

14. The method of claim 13 wherein the automatic transfer is triggered upon conversion of the raw tax data.

15. The method of claim 5 further comprising saving the standardized tax data to a duplicate file database if the standardized tax data has already been imported.

16. The method of claim 5 further comprising saving the standardized tax data to a reprocessing database if an error occurs during the importation of the standardized tax data.

17. The method of claim 5 further comprising saving the standardized tax data to an archive if the importation of the standardized tax data is successful.

18. The method of claim 5 wherein the automatic importation of the standardized tax data is triggered upon receipt of transferred standardized tax data.

19. A method for providing data to tax preparation software, comprising:
receiving raw tax data from a user;
converting the raw tax data into standardized tax data;
automatically triggering transfer of tax data to a tax service provider system; and
importing the standardized tax data into the tax preparation software for processing.

20. The method of claim 19 wherein automatically triggering transfer occurs before converting the raw tax data.

21. The method of claim 19 wherein automatically triggering transfer occurs upon detection of an available data file.

22. The method of claim 19 wherein automatically triggering transfer occurs upon conversion of the raw tax data.

23. A machine readable medium having embodied thereon a program, the program providing instructions for a method for providing data to tax preparation software, the method comprising:
receiving raw tax data from a user;
converting the raw tax data into standardized tax data;
automatically triggering transfer of tax data to a tax service provider system; and
automatically triggering importation of the standardized tax data into the tax preparation software for processing.
